(19) United States
(12) Patent Application Publication
(10) Pub. No.: US 2006/0282777 A1
(43) Pub. Date: Dec. 14, 2006

(54) Batch processing of images

(75) Inventors: William F.G. Gallafent, The Old Vicarage (GB); Timothy Milward, Cowley (GB)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Bourbay Limited, London (GB)

(21) Appl. No.: 11/408,611

(22) Filed: Apr. 21, 2006

(30) Foreign Application Priority Data
Apr. 21, 2005 (GB) GB 0508073.4

(51) Int. Cl. G11B 27/00

(52) U.S. Cl. 715/726

(57) ABSTRACT

Methods and apparatus are disclosed for manipulating digital images. The methods comprise the steps of: providing input data including image data specifying one or more digital images and template data comprising one or more masks, each mask specifying a region of the images having a predetermined status; and modifying each image using the masks. The apparatus comprises at least one user interface element for providing input data including image data specifying one or more digital images and template data comprising one or more masks, each mask specifying a region of the images having a predetermined status; and a data processor for modifying each image using the masks.

### BACKGROUND OF THE INVENTION

The Publishing, Advertising and Print industries for example have a requirement for the generation of large volumes of similarly presented images, produced generally but not exclusively from a studio environment, which must be prepared such that they may be overlaid on to a suitable background, together with text and other graphical elements, to provide a visually consistent effect, each image's background being replaced by the appropriate part of the layout's background, the composition being unintrusive and seamless, giving the impression of a single uniform style, e.g. for use in catalogues.

At present, conventional tools running on desktop computers with human interaction are used to perform a suitable extraction process, on an image-by-image basis, without automation. Users must repeatedly perform similar sets of operations to produce the compositable version of each image. This has the disadvantages of being time-consuming, and of being likely to produce inconsistent results, since different users' techniques will differ, as will time constraints (and thus users' exactitude).

We have appreciated a need for tools which allow the conversion of large numbers of complete digitised photographic images into partially masked images, whereby, for example, the background from the original image is made transparent, so that the image may be overlaid on to other backgrounds, with edge detail preserved, and original background pollution and shadows removed. We have also appreciated that in some applications, additional elements such as false shadows or lighting effects may be added to the compositable image. We have further appreciated that user interaction should be minimised, and that consistency of results is important.

### SUMMARY OF THE INVENTION

In a first aspect, the present invention provides a method for manipulating digital images comprising the steps of: providing input data including image data specifying one or more digital images and template data comprising one or more masks, each mask specifying a region of the images having a predetermined status; and modifying each image using the masks.

In a second aspect, the present invention provides a system for manipulating digital images comprising: means for providing input data including image data specifying one or more digital images and template data comprising one or more masks, each mask specifying a region of the images having a predetermined status; and means for modifying each image using the masks.

### BRIEF DESCRIPTION OF THE FIGURES

FIG. 1 shows an exemplary mode of selecting and collating images;

FIG. 2 shows a first exemplary mode of collection or generation of a mask;

FIG. 3 shows a second exemplary mode of collection or generation of a mask;

FIG. 4 shows an exemplary mode of specifying desired shadow parameters;

FIG. 5 shows an exemplary mode of specifying colour cast adjustment parameters;

FIG. 6 is a flow chart of an image processing method according to the invention; and

FIG. 7 shows a first mode of assessing modified images and accepting, rejecting or reprocessing modified images.

### DESCRIPTION OF PREFERRED EMBODIMENTS OF THE INVENTION

The present invention may be used in conjunction with any suitable digital image manipulation techniques including those described in our earlier British patent application published under GB 2,405,067 and in our earlier International patent application no. PCT/GB2005/000798, both incorporated herein by reference.

One method according to the present invention involves a three step process. The first step, which may be referred to as the interactive set-up phase, may involve a degree of human interaction to create suitable input data to specify how digital images are to be manipulated. The next step, which may be referred to as the automated run phase, is an automated process performed without human interaction using the input data previously created to automatically produce suitably manipulated digital images. The third step, which may be referred to as the interactive assessment phase, may involve a degree of human interaction in which the resulting digital images are assessed, and if necessary the images that are unsatisfactory may be discarded or re-processed.

The method may be carried out for example with the aid of any suitable computer system capable of manipulating digital images according to specified input data. One exemplary system comprises a data processor or CPU arranged to perform various operations to manipulate digital images. The system also comprises a display such as a monitor to allow the user to view various digital images and to display a user interface. The system further comprises one or more input device such as a mouse, keyboard and the like to allow the user to input data and to operate the user interface.

Interactive Set-up Phase

Initially, an operator or user performs the following sub-steps, which are performed to create the input data for the system. In some embodiments, a helper application may be used to provide a framework in which these data are generated and subsequently dispatched to the processing system.

A first sub-step comprises selecting and collating a group of images, for example by creating a simple text file listing the location of each image. A second sub-step comprises specifying a ‘template’ selection, representing areas of the image guaranteed to be background and/or foreground in all the images in the set. A third sub-step comprises specifying other parameters for modifications to the image apart from the selection templates, for example whether shadow is to be retained or removed, whether a fabricated ‘drop-shadow’ is to be created, and if so its density and angle, or whether to alter the tint of all colours in the image to give an impression of certain lighting conditions.

Some examples of the data taken as input to the automated processing system are described in greater detail below. Some exemplary methods by which these may be generated are also described. Some of the examples described may involve the use of a ‘helper application’, which provides the services described in all of the examples, acting as an infrastructure for collating the inputs, dispatching them to the CPU or ‘engine’, and collating and presenting the returned results. Though such a helper application provides a convenient mode of operation, it is not essential; the data in question may be generated and fed to the engine in any other suitable way.

The first sub-step of the interactive set-up phase comprises selecting and collating a set of images to process.

The images need not be of the same size or aspect ratio. To obtain the most consistently successful correct results, however, they should have broadly the same visual characteristics, for example position of a foreground object (to be retained for example) or the nature (for example colour or direction of lighting) of the background.

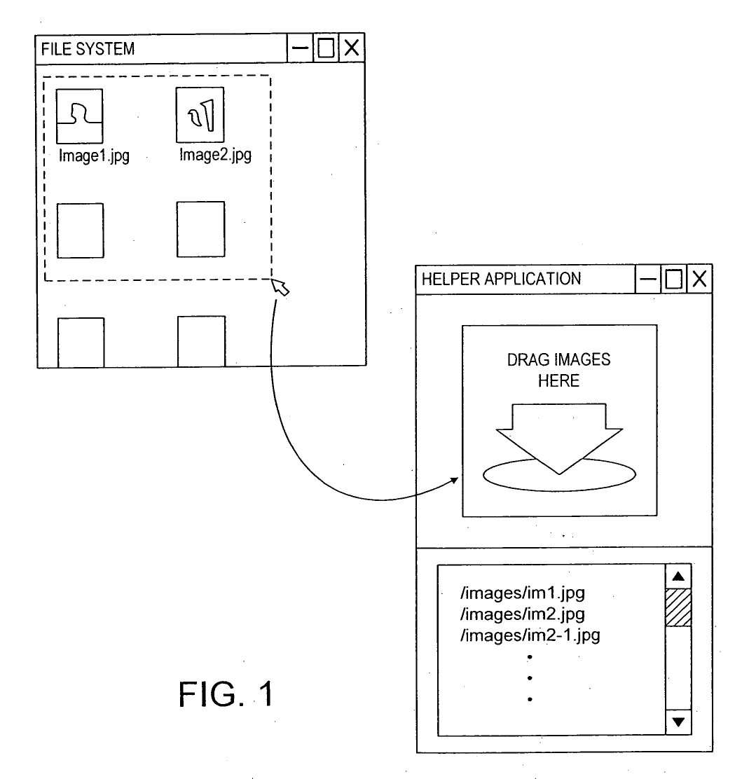

A first exemplary mode of selecting and collating the images is illustrated in FIG. 1. In this example, the user selects images via a user interface element, e.g., by clicking and dragging to select individual files and groups of files in a conventional file manager window of a personal computer, and then copies/pastes or drags the selection, optionally several times, to the helper application window, which constructs a set of references to all the images.

In a second exemplary mode of selecting and collating the images, the user provides a text file containing a list of file names in the file system of the computer. One example of a suitable format for each entry in the list is as follows. In this example, everything following a ‘#’ until the next new line is a comment, and a ‘\’ signifies that the next line should be considered a continuation of the current one.

#List of images to be processed
images=\
cat.jpg\
dog.png\
marmoset.bmp\
owl.ppm\
pomelo.png\
tamarin.tif\

The second sub-step of the interactive set-up phase comprises specifying one or more template selections to be applied.

These comprise an image mask, which represents, for example, an area of each image which will be considered to be solid background. Optionally, a second mask may be supplied, indicating an area in each image which will be considered foreground for example. Further masks, representing, for example, areas of shadow, translucent material, etc., may also be supplied. As described in greater detail below, an image mask may be expanded to define a larger area representing the part of the image having the same status as the original area defined by the image mask. The status of an area or individual pixel of an image indicates for example whether that area or pixel is a background, foreground or object edge region of the image, or indicates a visual characteristic of the area or pixel. For example, if the image mask represents an area of background then the expanded area may represent the whole background region of the image.

In addition, the style of selection of areas of the image for a mask may be specified, for example, to define whether the expansion of an area represented by a mask is to be made locally (expanding only in to contiguous areas of the image) or globally (allowing the expanded area to comprise non-contiguous areas of the image).

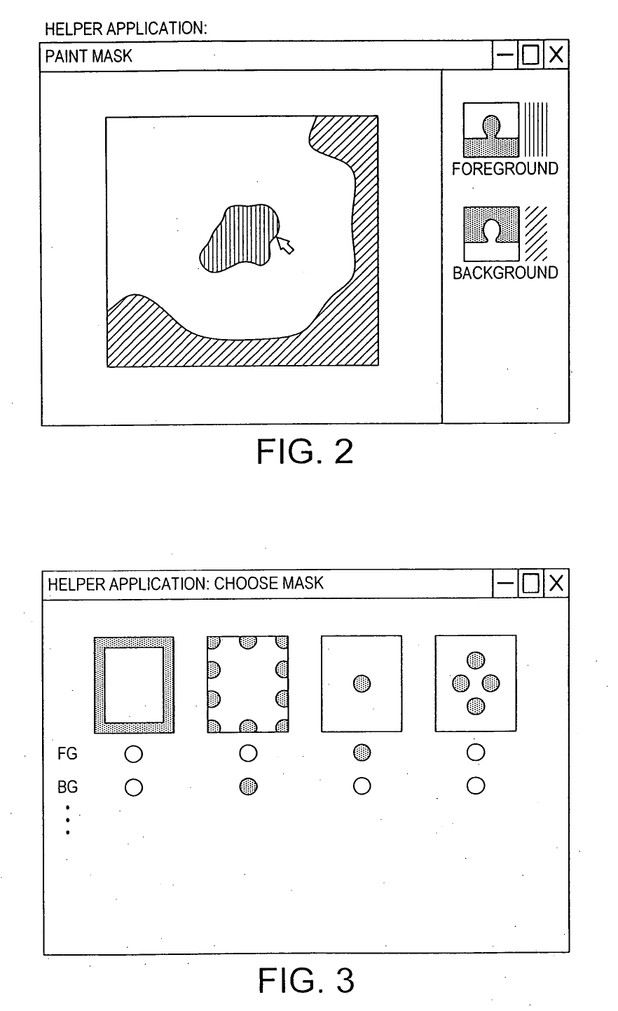

A first exemplary mode of collection or generation of a mask is illustrated in FIG. 2. In this example, a painting application presents the user with a painting window. The painting window may be for example square shaped or have the average aspect ratio of the supplied images (if the images have been selected yet). The user then paints arbitrary shapes, or selects geometric shapes in the painting window, or indicates sets of pixels in some other way, to define areas of background (or other status as required such as foreground or edge).

A second exemplary mode of collection or generation of a mask is illustrated in FIG. 3. In this example, the painting application presents the user with a selection of predefined masks, and the user then chooses the most appropriate of the set. Masks in the set may include for example “A 5% border around the edge of the image” or “The left 15% of the image”. One mask is chosen for each status, such as foreground or background for example, which is to be used to make automatic selections during the processing.

In a third exemplary mode of collection or generation of a mask, the user may use another standard application to paint images representing each mask, for example where black represents areas not to be selected, white representing areas to be selected; the locations or file names of these masks may then be indicated to the CPU in a configuration file, which may be comprised of instructions of the following form.

#Selections
select_foreground=fgmask.pbm
select_background=bgmask.png

The third sub-step of the interactive set-up phase comprises specifying other parameters for modifications to the image.

A first example of further parameters includes parameters relating to a shadow policy.

If the source images require it, the user may specify the strategy to be adopted when processing areas of the image which are considered by the core algorithms to be shadow; whether they should be treated as background (and therefore removed from the final result), retained as shadow (i.e. included in the final result as a partially opaque area of black pixels, in order to produce a similar shadow effect when the result is overlaid on to a new background), or retained, being treated identically to areas of foreground in the image. In particular, the shadow may be removed in conjunction with the use of the “add fake shadow” option described below.

In one exemplary mode of specifying the desired shadow policy parameters, the helper application provides a choice control offering the three options to the user, who picks one according to her needs.

In another example, the user specifies a ‘shadow’ element in a configuration file, for example in the following format.

shadow=translucent
or
<shadow mode=“translucent” />

A second example of further parameters includes parameter relating to fake shadow generation.

If the requirement exists to generate images which are all apparently viewed under the same conditions, it may be desirable to add a constructed shadow to the resulting image, in order to give the impression that light was falling on to the object from a certain direction. This shadow can be generated automatically, for example according to the following parameters.
1. density: describes the “depth of the shadow”. A density of 1.0 specifies that the shadow should be completely black. 0.0 specifies the absence of shadow, and numbers in between specify a partially opaque shadow.
2. colour: describes the colour that should shadowed areas tend to. Conventionally this may be black, but it may be desirable to use a different colour, particularly in combination with the lighting condition parameters described below.
3. offset: describes the offset from the bottom of the foreground to the bottom of the shadow. For example, to achieve the effect of an object standing on a horizontal surface viewed from the side, this offset should be small or zero. To achieve the effect of an object floating horizontally above an horizontal surface, viewed from above, the offset should be non zero and the orientation vector (below) should be vertical and of length one.
4. orientation: describes the angle at which the shadow should be cast, and the ratio of the length of the shadow to the height of the original object being shadowed.
5. scale: describes the size of the shadow, as a proportion of the size of the foreground object. For example, 1 may produce a shadow that is the same size as the foreground object, a value greater than 1 produces a shadow bigger than the object, and a value less than 1 produces a smaller shadow than the object.
6. softness: describes the amount of blurring or softening to be applied to the edge of the applied shadow, between 0, meaning a sharp edge with full shadow juxtaposed with unshadowed area, with increasing values increasing the distance over which the shadow transitions from unshadowed to fully shadowed at edges.

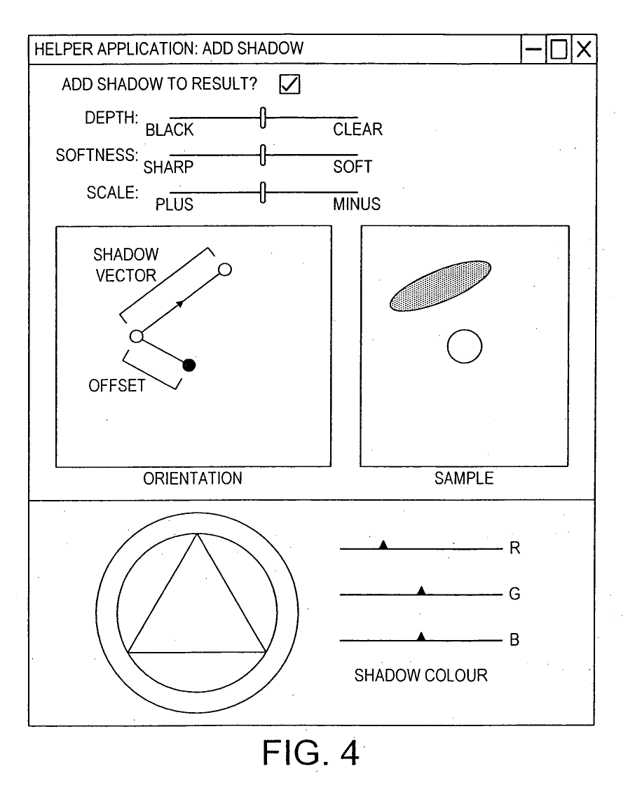

A first exemplary mode of specifying the desired fake shadow parameters is Illustrated in FIG. 4. In this example, the helper application presents the user with a GUI slider element with a range between 0 and 1 for depth, a second slider with a range between 0 and 1 for softness and a third slider with a range between 0 and a value greater than one for scale. The helper application also presents the user with a vector, the ends of which may be dragged to define the offset and angle of the shadow. The helper application also presents the user with a thumbnail sample image with a foreground and shadow, in which the adjustment of the parameters according to each control are reflected in the appearance of the thumbnail. A checkbox is used to indicate whether or not the shadow should be added.

In a second exemplary mode of specifying the desired fake shadow parameters, the parameters are specified in a configuration file which may contain instruction of the following form.

# Shadow density (0 = transparent, 1 = solid black)
shadow_density=0.6
# Shadow colour, (R,G,B), (Each channel from 0 - 1)
shadow_colour=0.2,0.3,0.1
# Shadow vector (x,y) (magnitude = ratio to height of
# object, direction = direction in which shadow is cast)
shadow_orientation=0.2,0.5
# Shadow offset (x,y) (offset of bottom of shadow compared
# to bottom of foreground) (distance as a proportion of image height)
shadow_offset=0.02,0.05
# Shadow scale (size of shadow as a proportion of size of
# foreground)
shadow_scale=0.8
# Shadow softness (0 = sharp, 1 = softest)
shadow_softness=0.2

A third example of further parameters includes parameter relating to colour cast adjustment.

It may be desirable, if the result images are required to present global colour characteristics which differ from those of the original images (for example to give the impression that they were photographed under certain lighting conditions), to apply a colour tint to the foreground image. Parameters may include for example colour, strength and method. Colour defines the colour to be applied, strength the amount of colour tint to be applied, and method the way in which the colour may be applied, for example by blending with image colour, by scaling image colour channels according to value in corresponding channel of tint colour, or by any other calculation depending on the desired effect.

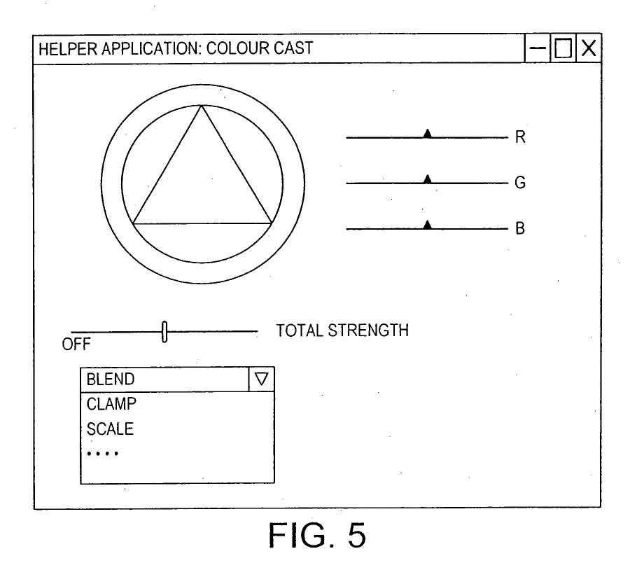

A first exemplary mode of specifying the colour cast adjustment parameters is illustrated in FIG. 5. In this example, a colour to apply, a strength and a measure are specified in the helper application using a standard colour picker, a slider and a choice control. A checkbox is used to indicate whether or not the colour cast should be adjusted.

In a second exemplary mode of specifying the desired fake shadow parameters, the parameters are specified in a configuration file which may contain instruction of the following form.

#Colour cast colour, (R,G,B), (Each channel from 0 - 1)
colour_cast=0.9,0.95,0.8
#Colour cast strength - how much mixing with the cast colour
#should be applied, 0 = no mixing, 1 = solid
colour_cast_strength=0.1
#Colour cast method
colour_cast_method=linear_blend

Other parameters which may be required by the core transformations (cutting out, shadow removal, shadow addition and colour alteration), or by another transformation which has been added to the framework and will automatically be applied to each image during the automatic processing, may also be specified in a configuration file, using the helper application, or by any other suitable method.

Automated Run Phase

All parameters and masks determined during the interactive set-up phase as described above are passed to the CPU, which performs the selection and final mask generation using any suitable technique such as that described in our earlier International patent application no. PCT/GB2005/000798 (with the selection based upon the masks chosen (or drawn/painted) by the user). If desired the CPU may also perform effects processing on each image. The CPU then collates the resulting images in preparation for the final assessment phase.

After the parameters and input data have been defined in the interactive set-up phase, the automated run phase may be invoked, for example by pressing a button in the helper application or by running a command such as:

$ process_images -i images.list -c configuration.conf

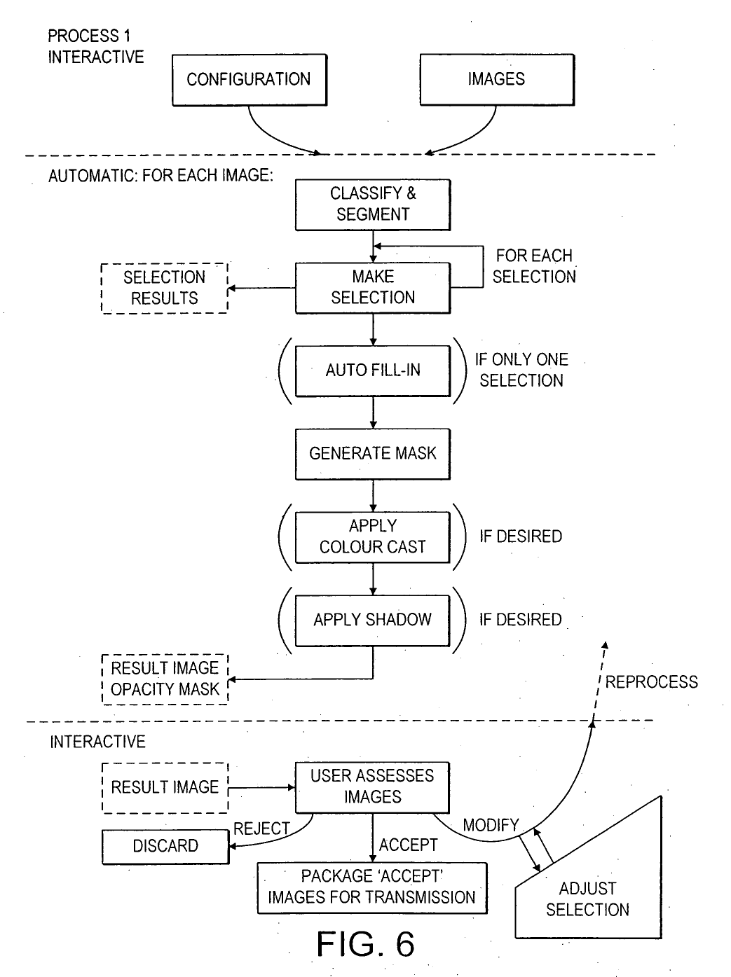

In one exemplary embodiment, the automatic process includes the steps described below and illustrated in FIG. 6 which may be performed for each image:
1. Any suitable segmentation process, such as that described in our earlier International patent application no. PCT/GB2005/000798, is applied to the image, producing a segmentation to be used in the next step.
2. For each status for which a mask is passed in (such as background, and optionally others), a selection is made using a method which takes advantage of the segmentation, for example using a method described in our earlier International patent application no. PCT/GB2005/000798. In this way, the initial masks are expanded, in a way which depends on the content of the image, to cover all pixels in the image, or a contiguous set of pixels, which belong to that status to define the selection. In some embodiments, the resulting selection may be retained, for example to allow modification in the final assessment phase detailed below.
3. If insufficient selections are made to explicitly define both a foreground and background area in the image, an automatic selection is made of the complement of the selection actually made (i.e. to automatically select background if only foreground was selected, or to automatically select foreground if only background was selected).
4. An opacity mask is generated, and the colour values and opacities of mixed pixels (being pixels for example whose visual characteristics are formed by a contribution from two or more objects in the image) are calculated and set in the output image, using a method such as that described in our earlier British patent application published under GB 2,405,067 to infer true foreground colours and opacity levels for mixed pixels which are not found in the solid foreground or background areas. An opacity mask may be generated, for example, from an image mask representing a region of the image at the boundary between two objects where blending may occur.
5. If a colour cast is to be applied, adjust the colours in the foreground image according to the chosen cast colour and application algorithm as chosen by the user.
6. If a shadow is to be added, then an algorithm is invoked to generate it For example, one suitable algorithm involves generating a greyscale image corresponding to the foreground part of the result image; transforming that image according to the transformation vector and offset; softening according to the softness parameter; and adding it to the result image, where foreground is not present.
7. The modified foreground image, and the opacity mask, are stored on disc for example.

In some embodiments, if sufficient processing and memory resources are available, more than one image may be processed concurrently.

The result of the automated run phase is that each specified image is processed according to the template selections. For example, each image is processed according to the masks and parameters to modify the shadows, colouring and other visual aspects of particular regions of each image defined by the template selections. Each image may be processed according to the image masks to define selections representing the foreground, background and/or other regions of each image. Each image may then be processed, for example to cut out the foreground portion of each image and superimpose each onto new backgrounds to generate composite images.

Interactive Assessment Phase

The resulting compositable images generated in the automated run phase are presented to the user, who can accept, reject or modify each one. The images may be modified for example by altering the template selection used for one or several images. Rejected images may, for example, be discarded, accepted ones archived and possibly forwarded to any further processing stages, and ‘modify’ images may be resubmitted as a new batch job with revised parameters.

After all the images have been processed in the automated run phase to produce an output image corresponding to each input image, the user assesses the output, classifying each image according to its completeness as “acceptable”, “needs modification” or “unacceptable”.

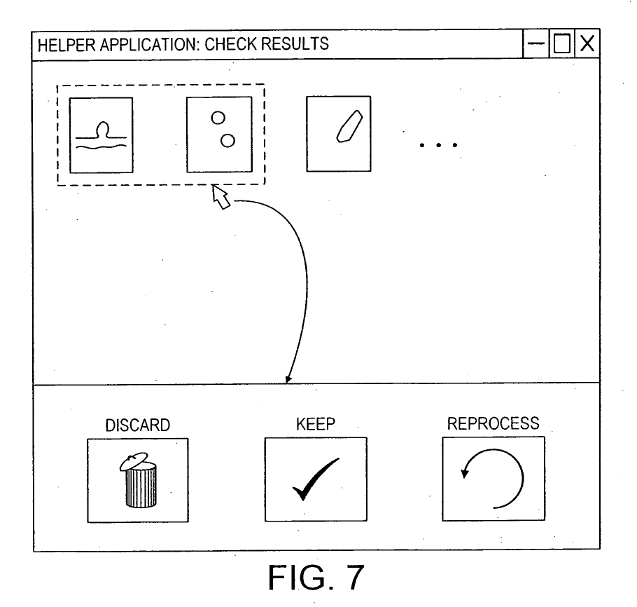

For example, as illustrated in FIG. 7, the user may be presented with a thumbnail view of all the result images, such as composited on to a chessboard pattern or strong bright colour to aid assessment of quality, by the helper application. A full scale view of each image may be obtained, for example by double-clicking on the thumbnail for the image in question.

According to the user's decisions, the three sets of result images thus chosen are dealt with accordingly:

Acceptable images require no further processing, and so may be archived for transmission to another system for any further processing steps, such as composition in to a page layout, or may be copied to a specified location in the file system.

Unacceptable (or irredeemable) images may be deleted, or may be stored in the file system for later assessment as part of a review and improvement of processes by the user or system provider, in order to improve performance with difficult images for subsequent work.

Images which need modification may be presented by the helper application to the user alongside the automatic background and foreground selections made for that image. These automatic selections may be modified by the user by means of painting and erasing tools for each image, before resubmitting this set of images for reprocessing and subsequent reassessment.

In alternative embodiments, if a helper application is not being used, the result images may be placed in the computer's file system, from which the user can view them and assess their quality. The assignment to good/bad/modify may then be performed by the user, who would copy acceptable images to an appropriate location for the next step of processing, archive them for transmission to another system to perform any necessary subsequent operations. Unacceptable images may be deleted. Images requiring modification may be resubmitted, together with their corresponding status maps as generated from the selections as described above, edited using a standard painting tool.

The present invention provides a fast and efficient means of manipulating large numbers of digital images. The unsupervised nature of the selections, and the consequent possibility of performing an unsupervised image-specific mask generation on many relatively heterogeneous images without intervention provides significant advantages over known techniques.

Advantageously, by working on batches of images with minimal human intervention, each batch having applied to it a set of rules, consistent output is produced for an entire batch of images. In addition, human interaction takes place at the start and end of processing only, freeing users to perform other tasks. While the intermediate processing takes place, no intervention is needed. At termination, the whole batch may be reviewed, each image being accepted, rejected or modified. This batched method of working allows concentration on single tasks rather than constant switching between modes for the user.

It is understood that while some of the steps described above have been describes as involving human intervention, at least some of these steps could alternatively be carried out automatically or semi-automatically.

1. A method for manipulating digital images comprising the steps of:
providing input data including image data specifying one or more digital images and template data comprising one or more masks, each mask specifying a region of the images having a predetermined status; and
modifying each image using the masks.

2. A method according to claim 1 comprising the further steps of:
assessing each modified image; and
accepting, rejecting or reprocessing each modified image according to the assessment.

3. A method according to claim 1 in which the step of providing image data comprises the steps of: in a graphical interface, dragging one or more elements in a file management window to a helper application window; and generating a set of references to the imaged represented by the elements.

4. A method according to claim 1 in which the step of providing image data comprises providing a text file identifying one or more images.

5. A method according to claim 1 in which the step of providing template data comprises the step of, in a graphical interface, specifying an area in a painting window to define a mask.

6. A method according to claim 1 in which the step of providing template data comprises the step of specifying one or more predetermined masks.

7. A method according to claim 1 in which the step of providing template data comprises the steps of: specifying an image mask; and determining a compliment of the specified image mask.

8. A method according to claim 1 in which a status of a region of an image indicates that the region is a background region.

9. A method according to claim 1 in which a status of a region of an image indicates that the region is a foreground region.

10. A method according to claim 1 in which a status of a region of an image indicates that the region is an edge region.

11. A method according to claim I in which a status of a region of an image indicates that the region includes shadows.

12. A method according to claim 1 in which the input data includes one or more parameters representing characteristics of visual aspects of each image.

13. A method according to claim 12 in which the parameters include parameters specifying the characteristics of a shadow region of an image.

14. A method according to claim 13 in which the parameters include at least one of a density, colour, offset, orientation, scale or softness parameter.

15. A method according to claim 12 in which one or more of the parameters are specified in a configuration file.

16. A method according to claim 12 in which one or more of the parameters are specified using a graphical interface.

17. A method according to claim 1 comprising the further step of deriving an expanded mask for an image from a mask, the expanded mask defining a region of the image which is larger than, and which has the same status as, the region of the image defined by the unexpanded mask.

18. A method according to claim 17 in which the step of deriving an expanded mask includes the steps of segmenting the image; and deriving an expanded mask based on the segmentation.

19. A method according to claim 1 in which the step of modifying each image comprises the step of modifying the shadow effects in an image using a shadow mask.

20. A method according to claim 1 in which the step of modifying each image comprises the steps of using a foreground mask to identify a foreground region of an image; and overlaying the foreground of the image onto a selected background to generate a composite image.

21. A method according to claim 20 in which the step of overlaying the foreground of the image onto a selected background comprises the step of using an opacity mask to blend the foreground with the selected background.

22. A method according to claim 1 in which the step of modifying each image comprises the steps of using a mask to modify a selected visual characteristic of a region of an image defined by the mask.

23. A method according to claim 1 in which the step of assessing each modified image comprises the step of presenting each image to a user on a display.

24. A method according to claim 1 in which the step of reprocessing each image comprises the step of modifying the template data or other parameters and reprocessing one or more images according to the modified template data and parameters.

25. A method according to claim 1 in which the step of assessing each modified image comprises the step of storing one or more images for later assessment.

26. A system for manipulating digital images comprising:
means for providing input data including image data specifying one or more digital images and template data comprising one or more masks, each mask specifying a region of the images having a predetermined status; and
means for modifying each image using the masks.

27. A system according to claim 26 further comprising:
means for assessing each modified image; and
means for accepting, rejecting or reprocessing each modified image according to the assessment.
